(19) United States
(12) Patent Application Publication
(10) Pub. No.: US 2008/0112373 A1
(43) Pub. Date: May 15, 2008

(54) Dynamic BSS allocation

(75) Inventor: Eran Shpak, Tel Aviv (IL)

Correspondence Address: BROWDY AND NEIMARK, P.L.L.C.;624 NINTH STREET, NW, SUITE 300, WASHINGTON, DC, 20001-5303, US

(73) Assignee: Extricom Ltd., Herzlia (IL)

(21) Appl. No.: 11/598,631

(22) Filed: Nov. 14, 2006

(51) Int. Cl. H04Q 7/24

(52) U.S. Cl. 370/338

(57) ABSTRACT

A method for communication includes establishing communications over a wireless local area network (WLAN) between one or more access points and a group of mobile stations in a first basic service set (BSS) using a first BSS identifier (BSSID). Upon detecting initiation of a communication session of a predetermined type involving a mobile station in the group, the mobile station is assigned to a second BSS having a second BSSID. The communication session continues by transmitting and receiving signals between an access point in the WLAN and the assigned mobile station using the second BSSID.

### FIELD OF THE INVENTION

The present invention relates generally to wireless communications, and specifically to methods and devices for improving the performance of wireless local area networks.

### BACKGROUND OF THE INVENTION

Wireless local area networks (WLANs) are gaining in popularity, and new wireless applications are being developed. The original WLAN standards, such as Bluetooth™ and IEEE 802.11, were designed to enable communications at 1-2 Mbps in a band around 2.4 GHz. More recently, IEEE working groups have defined the 802.11a, 802.11b and 802.11g extensions to the original standard, in order to enable higher data rates. In the context of the present patent application and in the claims, the term “802.11” is used to refer collectively to the original IEEE 802.11 standard and all its variants and extensions, unless specifically noted otherwise.

Stations in a conventional 802.11 WLAN can operate in two configurations:
Independent configuration, in which the stations communicate directly to each other, so there is no infrastructure need to be installed. Stations in this configuration are in a Basic Service Set (BSS). Typically, an access point, identified by a unique BSS identifier (BSSID), serves the stations in a BSS. One access point may serve multiple unique BSSIDs.
Infrastructure configuration, in which the stations communicate with access points that are part of a Distribution System. The set of one or more BSSs in this configuration is called an Extended Service Set (ESS). The ESS is identified by a service set identifier (SSID, also referred to as ESSID).

### The 802.11 standard provides for roaming by stations from one BSS to another within an ESS, but does not specify how such roaming is to be supported.

A number of alternatives to the conventional WLAN model have been proposed. For example, U.S. Patent Application Publication US 2004/0156399 A1, whose disclosure is incorporated herein by reference, describes a WLAN in which multiple access points communicate over the air on a common frequency channel with a mobile station using a common BSSID for all the access points. Multiple access points may thus receive an uplink signal transmitted over the WLAN by the mobile station on the common frequency channel. The receiving access points convey messages over a LAN to a switch. A manager node coupled to the switch receives and processes the messages so as to select one of the access points to respond to the uplink signal.

As another example, U.S. Patent Application Publication US 2002/0197984 A1, whose disclosure is incorporated herein by reference, describes apparatus for mobile communications in which a plurality of WLAN access points are linked together in a network. A control unit assigns logical identities to the access points, thus defining channels for use by mobile stations in a vicinity of the network in communicating over the air with the access points. The logical identities of the access points are separated from their physical identities. In other words, while the physical access points are generally fixed in specific locations, the control unit is able to assign different logical identities to the various access points at different times. Consequently, the control unit is able to allocate communication channels flexibly in different parts of the network, so that the channels move to or with the mobile stations. In this manner, communication cells, or their identities or allocated channels, can be attached to the user roaming about the network, rather than to the fixed physical access point.

### SUMMARY OF THE INVENTION

Embodiments of the present invention provide methods and systems for enhancing communication service over a WLAN. In some of these embodiments, one or more access points communicate with a group of mobile stations in a BSS using a certain BSSID, which may be used by multiple mobile stations simultaneously and may be shared among multiple access points, as described in the above-mentioned US 2004/0156399. The mobile stations typically use the WLAN for various types of communications, including data applications, such as Web browsing and e-mail, and real-time applications, such as Internet telephony and video conferencing.

A certain type or types of communications may benefit from having a particular BSSID dedicated to the mobile station while a communication session of this type is in progress. For this purpose, in some embodiments of the present invention, at least one other BSSID (in addition to the shared BSSID) is available to be assigned to an access point for use in communication sessions of a particular type or types with one of the mobile stations. This sort of BSSID assignment may apply to all mobile stations, or only to certain mobile stations in the WLAN. When the system detects initiation of a communication session of the specified type involving one of the mobile stations, it assigns the mobile station to a different BSS having a different BSSID. One of the access points is assigned to continue the communication session with the mobile station by transmitting and receiving signals to and from the mobile station using this different BSSID, while other mobile stations may continue communicating using the shared BSSID.

Implementation of the above features of the present invention may involve modification of the downlink transmission functionality of the access points, relative to access points that are known in the art, but requires no modification of the mobile stations served by these access points. In some embodiments, the uplink reception functions of the access points are handled substantially as described in the above-mentioned US 2004/0156399, for example, so that any access point may receive uplink transmissions from the mobile station that is served by the different BSSID. The mobile station may thus roam freely through the service area of the WLAN.

There is therefore provided, in accordance with an embodiment of the present invention, a method for communication, including:

establishing communications over a wireless local area network (WLAN) between one or more access points and a group of mobile stations in a first basic service set (BSS) using a first BSS identifier (BSSID);

detecting initiation of a communication session of a predetermined type involving a mobile station in the group;

responsively to detecting the initiation, assigning the mobile station to a second BSS having a second BSSID; and

continuing the communication session by transmitting and receiving signals between any access point in the WLAN and the assigned mobile station using the second BSSID.

In some embodiments, the WLAN includes multiple access points, and establishing the communications includes exchanging messages between at least two of the access points and the mobile stations in the group using the first BSSID. In a disclosed embodiment, exchanging the messages includes communicating between the multiple access points and the mobile stations using a common frequency channel and service set identifier (SSID). The access points using the first BSSID have respective service areas within a region served by the WLAN, and the access points using the first BSSID may be arranged so that at least some of the service areas are not mutually isolated.

In disclosed embodiments, the communication session includes an interactive communication session, such as a packet telephone call.

In one embodiment, detecting the initiation includes detecting at least one feature of the communication session selected from a group of features consisting of a communication protocol used in the session and an increase in communication traffic associated with the session.

In a disclosed embodiment, assigning the mobile station includes making a determination that the mobile station belongs to a category of the mobile stations that require assignment to the second BSS, and assigning the mobile station to the second BSS responsively to the determination.

In some embodiments, establishing the communications includes establishing an initial communication link between a first access point and the assigned mobile station using the first BSSID, and assigning the mobile station includes instructing the first access point to disassociate the assigned mobile station from the first BSS and to begin transmitting the signals to the assigned mobile station using the second BSSID. In one embodiment, continuing the communication session includes making a determination that the assigned mobile station has moved away from the first access point and toward a second access point, and causing the second access point to transmit the signals to the assigned mobile station using the second BSSID, in place of the first access point, without interrupting the communication session. Additionally or alternatively, instructing the first access point includes causing the first access point to disassociate the assigned mobile station from the first BSS and to transmit a beacon conveying the second BSSID to the assigned mobile station.

In a disclosed embodiment, continuing the communication session includes transmitting the signals from the access point so as to prevent the mobile stations other than the assigned mobile station from joining the second BSS.

There is also provided, in accordance with an embodiment of the present invention, apparatus for communication, including:

one or more access points, which are arranged to communicate in a wireless local area network (WLAN) with a group of mobile stations in a first basic service set (BSS) using a first BSS identifier (BSSID); and

an access manager, which is coupled to the one or more access points so as to detect initiation of a communication session of a predetermined type involving a mobile station in the group, and responsively to detecting the initiation, to assign the mobile station to a second BSS having a second BSSID, and to choose an access point from among the one or more access points to continue the communication session by transmitting and receiving signals over the WLAN to and from the assigned mobile station using the second BSSID.

The present invention will be more fully understood from the following detailed description of the embodiments thereof, taken together with the drawings in which:

### BRIEF DESCRIPTION OF THE DRAWINGS

FIG. 1 is a block diagram that schematically illustrates a WLAN system, in accordance with an embodiment of the present invention; and

FIG. 2 is a flow chart that schematically illustrates a method for BSS assignment in a WLAN system, in accordance with an embodiment of the present invention.

### DETAILED DESCRIPTION OF EMBODIMENTS

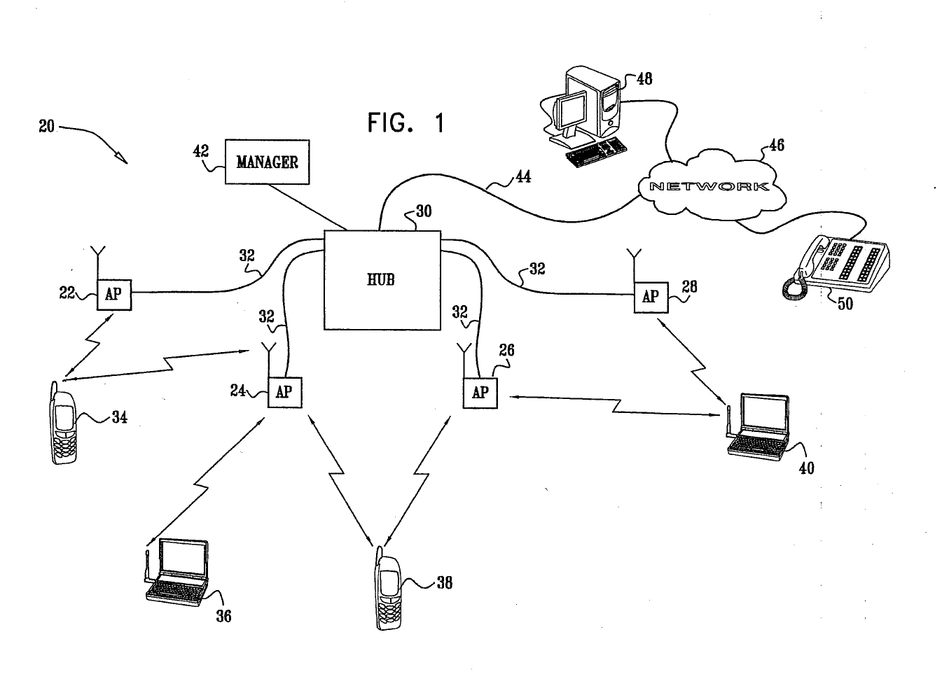

FIG. 1 is a block diagram that schematically illustrates a wireless LAN (WLAN) system 20, in accordance with a preferred embodiment of the present invention. System 20 comprises multiple access points 22, 24, 26, 28, which comprise wireless communication interfaces for communicating with mobile stations 34, 36, 38, 40. The mobile stations typically comprise computing devices, such as desktop, portable or handheld devices, with suitable communication interfaces and application software for WLAN communications. In the example shown in FIG. 1, and described further hereinbelow, some or all of the mobile stations (such as stations 34 and 38 in the figure) may be configured for mobile packet telephony. In some cases, these stations may have dual radio interfaces, enabling them to place and receive telephone calls over both a WLAN and over a cellular network.

In the exemplary embodiments described hereinbelow, it is assumed that the access points and mobile stations communicate with one another in accordance with one of the standards in the IEEE 802.11 family and observe the 802.11 MAC layer conventions. Details of the 802.11 MAC layer are described in ANSI/IEEE Standard 802.11 (1999 Edition), and specifically in Part 11: Wireless LAN Medium Access Control (MAC) and Physical Layer (PHY) Specifications, which is incorporated herein by reference. The principles of the present invention, however, may also be applied, mutatis mutandis, in other wireless environments, such as Bluetooth networks, personal area networks (IEEE 802.15), wireless metropolitan area networks (IEEE 802.16) and Ultra Wideband (UWB) networks.

Access points 22, 24, 26, 28, are interconnected by a communication medium, typically comprising a wired LAN 32 with a hub 30, such as an Ethernet switching hub. LAN 32 serves as the distribution system (DS) for exchanging data between the access points and the hub. Typically, the hub is also linked to one or more external networks 46, such as the Internet, via an access line 44, so as to enable the mobile stations to send and receive data through the access points to and from nodes connected to the external network. For example, the mobile stations may communicate via network 46 with a server 48 in connection with a data application (such as Web browsing or e-mail, for example), or with a telephone 50 in a telephony or video/audio conferencing application. (In the case of telephone communications, telephone 50 may comprise either a packet telephony terminal or a circuit-switched network telephone, reached via a suitable gateway.)

An access manager 42 controls downlink transmissions by access points 22, 24, 26, 28 in order to enhance the coverage and performance of the WLAN system. The access points may have overlapping service areas (i.e., service areas that are not mutually isolated) and operate on the same frequency channel and share the same BSS identifier (BSSID). Manager 42 selects one of the access points to communicate with each mobile station (usually the closest access point or one of the closest access points to the mobile station). Techniques that may be used for this purpose are described, for example, in U.S. Pat. No. 6,799,054 and in U.S. Patent Application Publications US 2003/0206532 A1, US 2004/0063455 A1 and the above-mentioned US 2004/0156399 A1, whose disclosures are incorporated herein by reference.

For conceptual clarity, manager 42 is shown as a separate unit within system 20, coupled to hub 30. In practice, the function of manager 42 may be integrated into the hub or into one of the access points, or distributed among the access points (assuming the hub or access points to have suitable processing resources for carrying out this function). Although embodiments of the present invention may require certain modifications to the functionality of conventional 802.11 access points to perform the operations described herein, the novel operation of the access points and of manager 42 is transparent to mobile stations 34, 36, 38, 40, which may operate in accordance with the 802.11 standards without modification.

Typically, WLAN system 20 may include additional access points operating on other frequency channels; but these additional access points do not interfere with communications on the frequency channel of access points 22, 24, 26 and 28, and therefore are not of concern here. Rather, the methods of access point control and collaboration provided by the present invention, as described hereinbelow with reference to access points 22, 24, 26 and 28, may be carried out independently by the set of access points on each of the operative frequency channels in the WLAN system.

Although the techniques of BSSID sharing that are described above are useful in enhancing WLAN coverage and efficiency of use of WLAN resources, some problems may remain in handling certain types of mobile stations and/or applications in system 20. For example, packet telephony applications are characterized by multiple, short exchanges of audio data between the mobile station and the serving access point. These applications generally require that the data rate and quality of the link between the mobile station and access point be consistently greater than certain application-dependent minima. (By contrast, data applications typically use longer messages and are more tolerant of rate and quality variations.) Some mobile handsets may even alert the user audibly when link quality drops below a recommended limit. The problems of data rate and link quality may be exacerbated when multiple mobile stations in mutual proximity share the same channel, as may occur when the WLAN is crowded, or when the mobile station roams through the service area of the WLAN during a call.

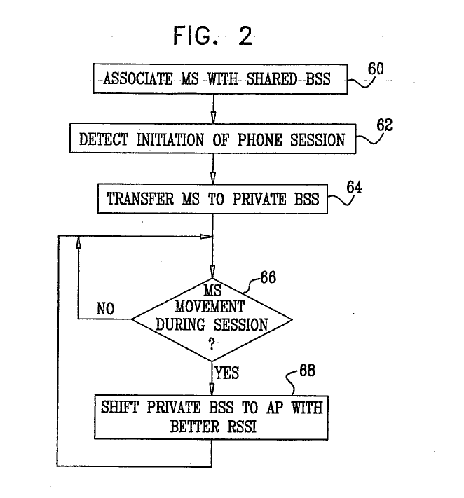

These problems are addressed in system 20 by assigning a “private” BSSID to serve individual telephone calls placed to or from certain mobile stations (or all the mobile stations) served by the WLAN. The method by which this assignment is carried out is described in detail hereinbelow with reference to FIG. 2. The BSSID is “private” only in the sense that it is used exclusively to communicate with the individual mobile station to which it is assigned, as opposed to the “public” BSSID that served the mobile station, along with other stations in the WLAN, prior to the telephone call. From the point of view of the mobile stations, as noted above, system 20 operates transparently in accordance with 802.11 standards. The public and private BSSIDs are indistinguishable to the mobile station from conventional WLAN BSSIDs, and the transition from “public” to “private” BSS uses methods of BSS association and disassociation that are defined by the 802.11 standard.

Manager 42 may assign a private BSSID to any mobile station conducting a telephone call over the WLAN. Alternatively, the manager may assign private BSSIDs selectively, to certain subscribers or certain types of mobile stations, for example. The access point that is assigned to transmit downlink messages to a given mobile station using the private BSSID ensures that the data transmission parameters are maintained within the appropriate limits to support the call. Typically, any of the access points may receive uplink messages transmitted by the mobile station using the private BSSID, and these messages are handled by the access points and by manager 42 in the same manner as uplink messages with the public BSSID. Should the mobile station move away from the assigned access point during the call, another access point, nearer the current location of the mobile station, may be assigned to transmit downlink messages using the private BSSID, so that the call continues without interruption or loss of quality. This access point re-assignment is transparent to the mobile station.

Although the embodiments described herein relate mainly to packet telephony applications, private BSS assignment may be used in other embodiments in connection with other types of communication sessions. For example, a private BSS may be assigned to a mobile station involved in other types of interactive applications, such as a video-conferencing session, or in another application in which consistent real-time performance is desirable. Alternatively or additionally, a private BSS may be assigned for use in a data session. The term “session” is used loosely in the present patent application and in the claims to refer to any aggregation of communication traffic of a particular type to and/or from a given mobile station during a defined time period. Telephone calls are one type of session, whose treatment is described in detail hereinbelow, but the principles of the present invention are similarly applicable to communication sessions of other types.

FIG. 2 is a flow chart that schematically illustrates a method for BSSID assignment, in accordance with an embodiment of the present invention. The method is described, for the sake of clarity, with reference to mobile station 34 (FIG. 1), but it may equally be applied to any mobile station in system 20 or in another WLAN system with similar capabilities. It is assumed that mobile station 34 belongs to a category of mobile stations (as explained above) that is designated in system 20 for assignment of a private BSSID during telephone calls.

When mobile station 34 is turned on or enters the service area of system 20, it exchanges association and authentication messages with access manager 42 through one of the access points in the system, at an association step 60. For example, mobile station 34 may transmit a probe request (such as a broadcast probe request or a probe request directed at a designated SSID), in accordance with the 802.11 standards, in order to identify available access points to which the mobile station may connect. The access points that receive the probe request (such as access points 22 and 24 in FIG. 1) typically measure the strength of the signal, and then forward a received signal strength indication (RSSI) to manager 42 together with the probe request.

Manager 42 selects an access point (access point 22 in the present example) to respond to mobile station 34, and returns a probe response to the mobile station through the selected access point. The probe response specifies a pre-designated SSID and the “public” BSSID that is shared by the access points in system 20, as explained above. The mobile station then exchanges authentication and association messages with access manager 42 through the access points, after which normal communications may proceed. The process that takes place at step 60 is described in greater detail in the above-mentioned US 2004/0156399. Alternatively, the process of association may start with transmission of a beacon by one of the access points, following which the mobile station responds and associates with the WLAN in the manner described above. In any case, manager 42 determines, based on the exchange of messages with the mobile station, that the mobile station belongs to one of the designated categories for assignment of a private BSSID, and therefore monitors communication traffic to and from the mobile station to determine when a private BSSID should be assigned.

Mobile station 34 continues to communicate intermittently with access point 22 using the public BSSID, until a telephone call involving the mobile station is initiated, at a call initiation step 62. The call may be initiated by mobile station 34, or it may alternatively be an incoming call from network 46 that is directed to the mobile station. Manager 42 analyzes the communication traffic in order to determine that a call has begun. The manager may use any of a number of techniques, or a combination of such techniques, for this purpose. For example, the manager may detect and analyze communication protocol messages, such as SIP (Session Initiation Protocol) messages, that are used in setting up packet telephone calls. Alternatively, the manager may be configured to function as a SIP proxy, whereby the manager is actively involved in call setup. Additionally or alternatively, the manager may receive a message from a telephony gateway (not shown in the figures) when a call is initiated. Further additionally or alternatively, the manager may monitor the volume of communication traffic to and from the mobile station, and may determine that a call has been initiated when the volume of traffic increases above some threshold level. Other methods of call detection will be apparent to those skilled in the art and are considered to be within the scope of the present invention.

Upon determining that a phone session involving mobile station 34 has been initiated, manager 42 transfers the mobile station to a private BSS, at a BSS transfer step 64. It is desirable (although not essential) that the transfer procedure take place during the call setup stage, before actual media transmission of voice and/or video begins, in order to minimize any interruption that the user may experience. For purposes of the transfer, the manager chooses one of the access points to transmit downlink messages using the private BSS. (As noted above, selection of the access point is transparent to the mobile station, and any of the access points may receive uplink messages from the mobile station using the private BSSID.) Typically, the manager chooses the access point that is nearest to mobile station 34, i.e., the access point that reports the strongest RSSI for signals received from the mobile station. In this case, it will be assumed that the manager initially chooses access point 22.

Manager 42 disassociates the mobile station from the public BSS and ESS by transmitting an appropriate message via access point 22. There are a number of methods provided by the 802.11 standards that may be used for this purpose. For example, the manager may transmit a de-authentication or disassociation message to the mobile station. This message causes the mobile station to seek a new BSS with which to associate.

The manager then instructs access point 22 to transmit a new beacon at regular intervals, identifying the private BSSID and SSID with which mobile station 34 is now to associate. Furthermore, the manager may instruct the access point to provide this information in response to a probe request packet sent by the mobile station. In either case, mobile station 34 completes the authentication and association processes using the new, private BSSID and can now continue the telephone call through the private BSS.

While mobile station 34 is conducting the call through the private BSS, manager 42 does not use the private BSSID in responding to probe requests from any other access points and does not publish the private BSSID so that other mobile stations cannot associate with the private BSS. (Manager 42 may continue to serve other mobile stations using the original, public BSSID, during time intervals between transmissions to and from mobile station 34, i.e., the manager, as well as the access points, may use two or more different BSSIDs in rapid alternation.) If it is necessary for the manager to transmit additional beacons to mobile station 34, it uses a “hidden SSID,” i.e., the SSID is omitted from the beacons.

Therefore, the private BSSID remains assigned exclusively to mobile station 34. Manager 42 transmits a beacon to mobile station 34 via access point 22 as required and to maintain the appropriate data rate and transmitted signal strength in transmissions to mobile station 34 so as to ensure that the required quality level is consistently maintained throughout the call.

It may occur that mobile station 34 roams from place to place within the service area of system 20 during a call, at a movement step 66. Manager 42 typically detects the motion on the basis of RSSI readings provided by the access points. For example, both access point 22 and access point 24 may monitor uplink transmissions by mobile station 34 (even when the mobile station is using the private BSSID). If the manager determines that the RSSI measured by access point 22 is getting weaker over time, while that measured by access point 24 is getting stronger, it may conclude that the mobile station is moving away from access point 22 and toward access point 24.

In this case, in order to maintain good signal quality on the private BSS serving mobile station 34, manager 42 stops sending beacons via access point 22 and immediately starts sending beacon via access point 24, at a BSS shift step 68. This transfer of the private BSS is transparent to mobile station 34 and requires no new authentication or association to take place. The same sort of shift may take place repeatedly, from access point to access point, as the mobile station moves across the service area of the WLAN. In other words, the BSSID is “handed off” from one access point to the next, rather than handing off the mobile station from one BSS to another as in systems known in the art.

Typically, when manager 42 determines that the call has been terminated (based on protocol analysis, traffic volume, or other indicators, as noted above), it may disassociate the mobile station from the private BSS by sending a de-authentication or disassociation message via the access point serving mobile station 34. The manager can thus free system resources to handle other calls. The mobile station may re-associate with the public BSS in system 20 until another call is initiated.

Although the method of FIG. 2 was described above with relation specifically to mobile station 34, system 20 may be configured to assign a private BSS to each of a number of mobile stations simultaneously. For example, access point 22 may communicate with mobile station 34 using one private BSS, while access point 26 communicates with mobile station 38 using another. Optionally, in some circumstances, the same private BSS may be used to serve two or more mobile stations at the same time or sequentially.

It will thus be appreciated that the embodiments described above are cited by way of example, and that the present invention is not limited to what has been particularly shown and described hereinabove. Rather, the scope of the present invention includes both combinations and subcombinations of the various features described hereinabove, as well as variations and modifications thereof which would occur to persons skilled in the art upon reading the foregoing description and which are not disclosed in the prior art.

1. A method for communication, comprising:
establishing communications over a wireless local area network (WLAN) between one or more access points and a group of mobile stations in a first basic service set (BSS) using a first BSS identifier (BSSID);
detecting initiation of a communication session of a predetermined type involving a mobile station in the group;
responsively to detecting the initiation, assigning the mobile station to a second BSS having a second BSSID; and
continuing the communication session by transmitting and receiving signals between an access point in the WLAN and the assigned mobile station using the second BSSID.

2. The method according to claim 1, wherein the one or more access points comprise multiple access points, and wherein establishing the communications comprises exchanging messages between at least two of the access points and the mobile stations in the group using the first BSSID.

3. The method according to claim 2, wherein exchanging the messages comprises communicating between the multiple access points and the mobile stations using a common frequency channel and service set identifier (SSID).

4. The method according to claim 3, wherein the access points using the first BSSID have respective service areas within a region served by the WLAN, and wherein the access points using the first BSSID are arranged so that at least some of the service areas are not mutually isolated.

5. The method according to claim 1, wherein the communication session comprises an interactive communication session.

6. The method according to claim 5, wherein the interactive communication session comprises a packet telephone call.

7. The method according to claim 1, wherein detecting the initiation comprises detecting at least one feature of the communication session selected from a group of features consisting of a communication protocol used in the session and an increase in communication traffic associated with the session.

8. The method according to claim 1, wherein assigning the mobile station comprises making a determination that the mobile station belongs to a category of the mobile stations that require assignment to the second BSS, and assigning the mobile station to the second BSS responsively to the determination.

9. The method according to claim 1, wherein establishing the communications comprises establishing an initial communication link between a first access point and the assigned mobile station using the first BSSID, and wherein assigning the mobile station comprises instructing the first access point to disassociate the assigned mobile station from the first BSS and to begin transmitting the signals to the assigned mobile station using the second BSSID.

10. The method according to claim 9, wherein continuing the communication session comprises making a determination that the assigned mobile station has moved away from the first access point and toward a second access point, and causing the second access point to transmit the signals to the assigned mobile station using the second BSSID, in place of the first access point, without interrupting the communication session.

11. The method according to claim 9, wherein instructing the first access point comprises causing the first access point to disassociate the assigned mobile station from the first BSS and to transmit a beacon conveying the second BSSID to the assigned mobile station.

12. The method according to claim 1, wherein continuing the communication session comprises transmitting the signals from the access point so as to prevent the mobile stations other than the assigned mobile station from joining the second BSS.

13. Apparatus for communication, comprising:
one or more access points, which are arranged to communicate in a wireless local area network (WLAN) with a group of mobile stations in a first basic service set (BSS) using a first BSS identifier (BSSID); and
an access manager, which is coupled to the one or more access points so as to detect initiation of a communication session of a predetermined type involving a mobile station in the group, and responsively to detecting the initiation, to assign the mobile station to a second BSS having a second BSSID, and to choose an access point from among the one or more access points to continue the communication session by transmitting and receiving signals over the WLAN to and from the assigned mobile station using the second BSSID.

14. The apparatus according to claim 13, wherein the one or more access points comprise multiple access points, which are configured to exchange messages with the mobile stations in the group using the first BSSID.

15. The apparatus according to claim 14, wherein the multiple access points are configured to communicate with the mobile stations over a common frequency channel and using a common service set identifier (SSID).

16. The apparatus according to claim 15, wherein the access points using the first BSSID have respective service areas within a region served by the WLAN, and wherein the access points using the first BSSID are arranged so that at least some of the service areas are not mutually isolated.

17. The apparatus according to claim 13, wherein the communication session comprises an interactive communication session.

18. The apparatus according to claim 17, wherein the interactive communication session comprises a packet telephone call.

19. The apparatus according to claim 13, wherein the access manager is arranged to detect the initiation by detecting at least one feature of the communication session selected from a group of features consisting of a communication protocol used in the session and an increase in communication traffic associated with the session.

20. The apparatus according to claim 13, wherein the access manager is arranged to make a determination that the mobile station belongs to a category of the mobile stations that require assignment to the second BSS, and to assign the mobile station to the second BSS responsively to the determination.

21. The apparatus according to claim 13, wherein the chosen access point is arranged to communicate initially with the assigned mobile station using the first BSSID, and wherein the access manager is coupled to cause the chosen access point to disassociate the assigned mobile station from the first BSS and to begin transmitting the signals to the assigned mobile station using the second BSSID.

22. The apparatus according to claim 21, wherein the access manager is arranged to make a determination that the assigned mobile station has moved away from the chosen access point and toward a further access point, and to cause the further access point to transmit the signals to the assigned mobile station using the second BSSID, in place of the chosen access point, without interrupting the communication session.

23. The apparatus according to claim 21, wherein the access manager is arranged to cause the chosen access point to disassociate the assigned mobile station from the first BSS and to transmit a beacon conveying the second BSSID to the assigned mobile station.

24. The apparatus according to claim 13, wherein the signals are transmitted so as to prevent the mobile stations other than the assigned mobile station from joining the second BSS.
